(19) United States
(12) Patent Application Publication
(10) Pub. No.: US 2015/0227064 A1
(43) Pub. Date: Aug. 13, 2015

(54) METHOD FOR PERFORMING LIQUID ELECTROPHOTOGRAPHIC PRINTING

(71) Applicant: Hewlett-Packard Indigo B.V., Maastricht (NL)

(72) Inventors: Sergio Bandriss, Nes Ziona (IL); Raia Slivniak, Nes Ziona (IL); Inna Tzomik, Nes Ziona (IL); David Idan, Nes Ziona (IL); Amnon Levi, Nes Ziona (IL)

(73) Assignee: Hewlett-Packard Indigo B.V., Maastricht (NL)

(21) Appl. No.: 14/426,042

(22) PCT Filed: Sep. 21, 2012
(86) PCT No.: PCT/EP2012/068680

§ 371 Date: Mar. 4, 2015

(51) Int. Cl. G03G 7/00; B32B 27/08; B32B 38/00; G03G 15/10

(52) U.S. Cl. CPC G03G 7/0026; G03G 15/10; G03G 7/004; G03G 7/0046; B32B 27/08; B32B 38/145; B32B 2559/00; B32B 2323/046

(57) ABSTRACT

The present disclosure discloses a method for performing liquid electrophotographic printing, the method including: providing a printing medium, wherein said printing medium includes an ink-receiving layer and a second layer, the layers being coextruded, wherein at least the ink-receiving layer contains a material selected from the group consisting of ethylene copolymers, alpha-olefin copolymers, polyamides, polyurethanes, polyvinylpyrrolidones, polyethyleneimines, and mixtures thereof, and printing an image on said printing medium.

### BACKGROUND

Conventional liquid electrophotographic (LEP) printing processes include applying a liquid ink onto a printing substrate (e.g. paper or plastic). A primer may be applied onto the substrate prior to printing in order to favor the transfer of the ink from the blanket cylinder to the substrate and the adhesion of the ink on the substrate. The present disclosure discloses a method for performing liquid electrophotographic printing, a printed medium, a method for producing a printed medium and a method for producing a packaging using this printed medium.

### BRIEF DESCRIPTION OF THE DRAWINGS

FIG. 1A is a schematic representation showing an embodiment of a coextruded printing medium of the present disclosure.

FIG. 1B is a schematic representation showing another embodiment of a coextruded printing medium of the present disclosure.

FIG. 1C is a schematic representation showing an embodiment of a packaging containing a coextruded printing medium of the present disclosure.

### DETAILED DESCRIPTION

In digital offset printing processes, the PIP (Polycontrast Interference Photography) photo-conducting image plate may be charged by a scorotron or corona device then the PIP may be selectively discharged by a laser writing head. The selectively discharged PIP may subsequently be inked by a binary inking device (BID), the paraffinic liquid dispersion of electrically charged and pigmented toner (e.g. ElectroInk®) may be transferred to the PIP when the BID is brought to intimate contact therewith. Excess of solvent may be removed during the turns of the PIP drum, then the dried material deposited on the PIP may be transferred to a drum covered by an elastomeric blanket. This blanket is heated so that the ElectroInk dries and forms a film layer.

When a multiple-shot printing process is used, the film located on the blanket drum is directly transferred to the substrate to be printed. In contrast, in a one-shot process, the film is held on the blanket whilst the PIP plate is cleaned, charged, inked with the desired ElectroInk color, transferred to the blanket and the process repeated until all the ink layers of the graphic design are in place then the whole design will be transferred to the substrate at once.

Primers, also known as binders, adhesion enhancers or promoters, may be used when printing with liquid toners on different substrates such as papers or plastics. They usually favor the adhesion of the ink on the substrate as well as facilitate the transfer of the ink from the blanket drum (or cylinder) to the substrate.

Primers tend to be more useful when a one-shot printing process is used.

Coatings of primers may be done by different techniques including but not limited to flexo costing, gravure or screen printing. For instance, in flexo coating, the primer formulation will be poured or pumped into a pan or chamber doctor blade. An engraved roll with the desired engrave to render a desired wet coating laydown is partially dipped in the pan or put in contact with the chamber. Excess of liquid are removed or “doctored” by a knife (doctor blade) and the engraved roll is brought in contact with a rubber roll that transfers the wet layer of primer to the substrate. The wet coated substrate is then dried in an oven. Driers which may be used include air flow driers, hot air driers, UV or IR irradiation driers.

Primers used for liquid printing include polyethylene imine resins, polyamide resins, polyurethane, ethylene acrylic or methaacrylic acid resins.

Utilizing primer coating adds an additional step in the process of the printing chain. This extra step may increase the cost and duration of the printing process. Primers may also influence the physical properties of the substrate by impacting on certain characteristics thereof such as gloss, whiteness and smoothness.

Removing the priming step would thus contribute to reduce the cost and duration of a LEP printing process as well as preserve the physical properties of the substrate which may adversely affected during the printing process.

In packaging processes, the LEP ink (or ElectroInk®) may suffer from rheology related failures under high temperature conditions so that currently used primers may present thermal failures in the primer-substrate interface.

One aspect of the present disclosure pertains to a method for performing Liquid Electrophotographic (LEP) Printing which includes the provision of a printing medium, wherein said printing medium contains an ink-receiving layer and a second layer, the layers being coextruded, wherein at least the ink-receiving layer includes a material selected from the group consisting of ethylene copolymers, alpha-olefin copolymers, polyamides, polyurethanes, polyvinylpyrrolidones, polyethyleneimines, and mixtures thereof, and the printing of an image on said printing medium.

In the present description and unless otherwise indicated, “electrophotographic printing” refers to the process that provides an image that is transferred from a photo imaging substrate either directly or indirectly via an intermediate transfer member. As such, the image is not substantially absorbed into the photo imaging substrate on which it is applied. Additionally, “electrophotographic printers” refers to those printers capable of performing electrophotographic printing, as described above. “Liquid electrophotographic printing” is an electrophotographic printing where a liquid ink is employed rather than a powder toner.

Coextrusion can be seen as the extrusion of multiple layers of material simultaneously thereby leading to a product in which the layers are stacked. Coextrusion may utilize two or more extruders to melt and deliver a steady volumetric throughput of different viscous materials to a single extrusion head (die) which will extrude the materials in the desired form. This technology may be used as part of many processes such as blown film, overjacketing. tubing, sheet. The layer thicknesses may be controlled by the relative speeds and sizes of the individual extruders delivering the materials. The materials of each extruder do not mix in the die. Rather, the material layers are combined and flow out of the die as a stacked multilayer product. This product may subsequently go through cooling, heating, healing and other manufacturing processes.

Being obtainable by coextrusion, the printing medium presently disclosed includes an ink-receiving layer and a second layer stacked in this order. The medium thus includes an ink-receiving surface which is part of the ink-receiving layer and an opposed surface which is part of the second layer.

With reference to the appended Figures, one embodiment of the printing medium used in the method for performing LED printing of the present disclosure may be formed by co-extrusion of three layers of material. The number of layers is of course not limited to three and may be four, five, six, seven or more layers but three to ten layers have certain advantages. Each co-extruded assembly has an ink-receiving layer and a second layer and may have any suitable number of layers sandwiched therebetween. In other words, if one or more additional layers are co-extruded together with the ink-receiving layer and the second layer as presently defined, the printing medium may include the ink-receiving layer, the one or more additional layers and the second layer stacked in this order (i.e. the one or more additional layers are sandwiched between the ink-receiving and the second layers). In this manner and irrespective of how many additional layers are present, the resulting printing medium will always have an ink-receiving surface available to receive an ink, i.e. available for printing. The one or more additional layers that may be present between the ink-receiving layer and the second layer may be also referred to as “inner” layers.

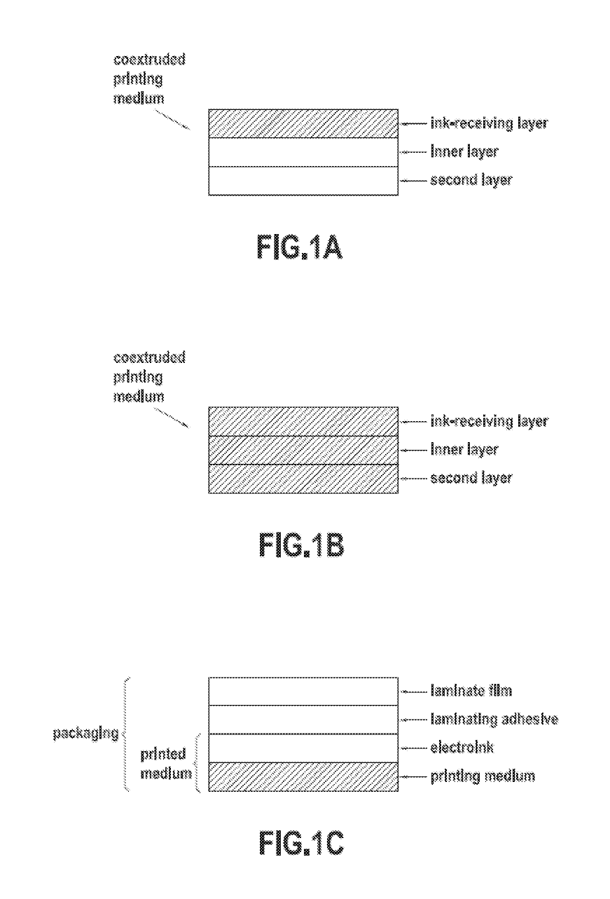

As shown in FIGS. 1A and 1B, one example of the printing medium is made of three co-extruded areas or layers, one ink-receiving layer, one inner layer and one second layer.

Within a printing medium used in a method of the present disclosure, the ink-receiving layer may be the layer responsible for imparting properties such as appearance, printability, tactile qualities or weather resistance. The second layer may be the layer imparting properties such as sealing properties, resistance to materials, suitability to be in contact with food or pharmaceuticals, and when used to the production of a package, properties such as friction for runs against rolls or surfaces on machines. The inner layer(s) may be the layer(s) providing the bulk properties of the co-extruded assembly such as color, opacity, stiffness, thickness, barriers to different factors like humidity, oxygen or aroma.

In the specific embodiment shown in FIG. 1A, only the ink-receiving layer contains a material selected from the group consisting of ethylene copolymers, alpha-olefin copolymers, polyamides, polyurethanes, polyvinylpyrrolidones, polyethyleneimines, and mixtures thereof.

In another embodiment shown in FIG. 1B, all co-extruded layers each includes a material selected from the group consisting of ethylene copolymers, alpha-olefin copolymers, polyamides, polyurethanes, polyvinylpyrrolidones, polyethyleneimines, and mixtures thereof.

Within the context of the present disclosure, the co-extruded layers may all have essentially the same thickness or each have a different thickness in accordance with the desired physicochemical properties of the printing medium.

Suitable layer thicknesses for implementing embodiments of the present disclosure may be between about 1 μm and about 300 μm or between about 1 μm and about 200 μm or between about 1 μm and about 100 μm or between about 1 μm and about 50 μm or between about 1 μm and about 20 μm. In any case, the total thickness of the co-extrudate may be comprised between about 8 μm and about 800 μm. These values are simply indicative as, in practice, films and layers thicknesses may be adjusted based on parameters such as the physical capabilities of the extruder and economics considerations. Embodiments from which good results were obtained included co-extrudate wherein ink-receiving layer thicknesses were between about 1 μm and about 15 μm, and second layer thicknesses were between about 20 μm to about 60 μm.

These illustrated embodiments are of course not limiting and other multiple-layered printing medium should be considered as comprised within the scope of the present disclosure.

An ink-receiving layer as presently disclose includes or consists of a material selected from the group consisting of ethylene copolymers, alpha-olefin copolymers, polyamides, polyurethanes, polyvinylpyrrolidones, polyethyleneimines, and mixtures thereof.

In the present description and unless otherwise indicated, ethylene copolymers refer to ethylene acrylic acid and ethylene methyl methacrylate. Examples of ethylene-acrylic acid copolymers include Honeywell AC® 5180 EAA and Primacor® family from Dow.

In the present description and unless otherwise indicated, alpha-olefin copolymers refer to poly-alpha-olefin (or poly-α-olefin, sometimes abbreviated as PAO). An alpha-olefin (or α-olefin) is an alkene having a carbon-carbon double bond located at the α-carbon atom, in other words, the double bond is between the first and second carbons in the molecule. Common alpha-olefins used as co-monomers in the production of polymer alkyl branching groups include but are not limited to 1-hexene, 1-heptene, 1-octene and the like. Examples of such copolymers include Tafmers® from Mitsui chemicals America NY or Affinity® from DOW chemicals USA.

In the present description and unless otherwise indicated, polyamides refer to a polymer containing amides groups in which the repeating units in the molecular main chain are linked together by amide groups. Examples of such polymers include for instance Macromelt® 6239 from Henkel, Germany.

In the present description and unless otherwise indicated, polyurethanes (also known as PUR and PU) is polymer composed of a chain of organic units joined by carbamate (urethane) links.

In the present description and unless otherwise indicated, polyvinylpyrrolidones refer to a polymer that contains or is formed by the polymerization of N-vinylpyrrolidone. Examples of such copolymers include povidone Korrilidone® from BASF Germany.

In the present description and unless otherwise indicated, polyethyleneimines refer to amine containing polymer with primary, secondary and tertiary amines. Examples of such copolymers include Polymin® from BASF.

A second layer as presently disclosed may include a thermoplastic polymer which may be processed by extrusion (i.e. that is extrudable). Suitable thermoplastic polymers may include polyethylene (PE) polymers, polypropylene (PP) polymers, polyethylene terephthalate (PET) and polyamide (PA) polymers. Such thermoplastic polymers are usually employed in the production of plastic bags, premed pouches, form fill, seal packages, lids for cups and tray, wrap around, tag for plastic bottles, IML in mold labeling or shrink sleeves. An example of polyethylene polymer is low density polyethylene (LDPE). In one example, polyethylene (PE) polymers, polypropylene (PP) polymers, polyethylene terephthalate (PET) and polyamide (PA) polymers may be the only thermoplastic polymers contained in the second layer. In one example, the second layer includes LDPE as sole thermoplastic polymer.

In an embodiment of the present disclosure the printing medium may contain a second layer including low density polyethylene (LDPE) and an ink-receiving layer including a material selected from the group consisting of ethylene-vinyl acetate (EVA) polymer, ethylene acrylic acid (EAA) copolymer, ethylene methyl methacrylate (EMMA) polymer, ethylene alpha-olefin polymer (e.g. a Tafmer® polymer), and mixtures thereof.

In one embodiment, the second layer may include the same material(s) of the ink-receiving layer.

If present, the additional inner layer(s) may have the same composition of the second layer as defined above.

Suitable EVA polymer include Dupont Escorene® Ultra FL 02020 or EVA-resin escore 123.

The second layer as presently disclosed may also include additives which may usually be added includes processing agents such as one or more of agents for modifying coefficient of friction (COF) of the thermoplastic material(s), anti-blocking agents, pigments for imparting colors and fillers for imparting physical properties or barrier characteristics.

In one other embodiment, the printing medium used in the method of the present disclosure is in the form of a film.

The method for performing LEP printing of the present disclosure is particularly suited to be used within a Liquid Electrophotographic one shot printing process.

Another aspect of the present disclosure pertains to a printed medium which includes a printing medium as described above and a LEP ink layer, wherein said ink layer is in direct contact with said ink-receiving layer.

In the present description and unless otherwise indicated the term “in direct contact with” generally means that no other layer is present between the ink and the ink-receiving layer. In other words, the substrate or printing medium is not coated with a primer prior to receiving the ink layer.

In yet another aspect, the present disclosure discloses a method for producing a printed medium which includes coextruding an ink-receiving layer and a second later thereby obtaining a printing medium as described above and the printing of an image on said medium using LEP processes.

Suitable printing systems for realizing the printed medium of the present disclosure include any of the HP® digital indigo printing machines.

As indicated above, the ink-receiving layer of the present disclosure is thus sufficient to establish adequate ink adhesion and ink transfer without the need for the usual primer coating. Accordingly, the method for producing a printed medium disclosed herein may not include a step of coating of the ink-receiving layer with an adhesive promoter prior to the step of printing of the image.

In another aspect, the present disclosure relates to a printed medium obtainable by a method for producing a printed medium of the present disclosure.

Printed media obtainable as presently disclosed include PE, PET, biaxially-oriented polypropylene (BOPP), cast polypropylene (CPP) or PA films.

In yet another aspect, the present disclosure pertains to a method for producing a packaging which includes the provision of a printed medium as disclosed above, the coating of the printed medium with an adhesive, the provision of a film, and the contacting of the printed medium and the film. The adhesive may be applied onto the LEP ink layer so that the film is in turn applied onto the adhesive-coated LEP ink layer.

In the packaging material, the second layer of the printed medium may include a low density polyethylene (LDPE) while the film includes a polyester polymer.

The method has been found to allow one to provide packaging such as films for labels, folding films for packaging or signaling or any other flexible packaging wherein the obtained packaging product has increased adhesion strength between components and reduced rheology-related failures.

With reference to FIG. 1C, the printed medium of the present disclosure may be used in the production of packaging. The present disclosure allows for a primer-free packaging to be manufactured. The process for manufacturing such packaging thus contains less process steps and would therefore be more economic.

Suitable producing-packaging systems for implementing the method for producing a packaging of the present disclosure are described, for instance, in Fundamentals of packaging technology, Walter Soroka, CPP editor, institute of packaging professionals 4th edition 2009 USA page 392. For instance lamination processes may be used. Lamination processes combine at least two films together by adhesion thereby forming a single laminated film. This adhesion may be performed using different adhesives techniques which includes but are not limited to solvent based (or and water based) adhesives, solvent less adhesives, UV curable adhesives or extrusion lamination adhesion.

Suitable LEP inks to be used in conjunction with the aspects of the present disclosure include inks based on ethylene acrylic acid or ethylene methacrylic acids, or ethylene vinyl acetates.

Further embodiments and advantages will become apparent to a skilled reader in light of the examples provided below.

### EXAMPLES

A printing medium was obtained using the following extruders:
an industrial blown film Brampton Eng. (Canada) 3 layer extruder, and
a cast technology Dr. Collin Gmbh (Germany) lab 3 layers extruder.

### Materials

Escorene® Ultra FL 02020 EVA-resin was obtained from Exxonmobil, Belgium.
Honeywell AC® 5180 EAA resin was obtained from Honeywell, NJ, USA.
Tafmer®-4000-Mitsui resin was obtained from Mitsui, Singapore.
Ineos® 19 N 430-LDPE resin was obtained from Ineos UK.

### General Thickness Measurements Procedure

Thickness measurements were carried out by dividing the material consumption by the film dimension and confirmed by microscope measurement of the coextrudate's cross section. The microscope measurements were performed on an Olympus BX51 or an Olympus 3D measuring laser microscope OLS 4000.

### Production of Co-Extruded Printing Media

### Sample 1

A printing medium was obtained by co-extrusion using a Dr Collins gmbh extruder of a Escorene® Ultra FL 02020 EVA-resin as ink-receiving layer with a thickness of between 4-10 μm and an Ineos® 19 N 430 LDPE-resin as inner and second layers with thicknesses of between 20-40 μm for the inner layer and about 10 μm for the second layer. The total thickness of the printed medium was calculated to be between 34 and 60 μm.

### Sample 2

A printing medium was obtained by co-extrusion using a Dr Collin three layer cast extruder of a Honeywell AC® 5180 EAA resin as ink-receiving layer with a thickness of between 4-10 μm and an Ineos® 19 N 430 LDPE-resin as inner and second layers with thicknesses of between 20-40 μm for the inner layer and about 10 μm for the second layer. The total thickness of the printed medium was calculated to be between 34 and 60 μm.

### Sample 3

A printing medium was obtained by co-extrusion using a Dr Collin Coex 3-layer cast extruder of an EMMA Sumitomo WD301 resin as ink-receiving layer with a thickness of between 4-10 μm and an Ineos® 19 N 430-LDPE resin as inner and second layers with thicknesses of between 20-40 μm for the inner layer and about 10 μm for the second layer. The total thickness of the printed medium was calculated to be between 34 and 60 μm.

### Sample 4

A printing medium was obtained by co-extrusion using a Dr Collins Gmbh extruder of a Tafmer®-4000-Mitsui resin as ink-receiving layer with a thickness of between 4-10 μm and an Ineos® 19 N 430-LDPE resin as inner and second layers with thickness of between 20-40 μm for the inner layer and about 10 μm for the second layer. The total thickness of the multilayer was calculated to be between 34 and 60 μm.

### Reference Sample (Comparative Sample)

A printing medium was obtained by co-extrusion using plastic extrusion of an Ineos® 19 N 430-LDPE resin as ink-receiving, inner and second layers with a thickness of between 4-10 μm for the ink-receiving layer, of between 20-40 μm for the inner layer and of about 10 μm for the second layer. The total thickness of the multilayer was calculated to be between 34 and 60 μm.

### Production of Printed Media

Printing media of Sample 1 to 4 and of Reference sample were each combined with a carrier PET film and printed on a HP indigo WS 6000 digital printer. The roll obtained from the co-extruder was loaded in the printer without any further preparation. Standard setup parameters of pressure and temperature were used. The target print was a synthetic work that comprised patches of different colors and coverage starting from 20% to 450% including the basic colors for print Yellow, Magenta, Cyan and Black, the print also included the use of white Electroink. DOW Adcote® 811A+CatF were used as a laminate adhesive.

### Example 1

Sample 1/HP-Indigo INK/DOW Adcote® 811A+CatF/SRF Limited-PET film Petlar PR.

### Example 2

### Sample 2

Sample 2/HP-Indigo INK/DOW Adcote® 811A+CatF/SRF Limited-PET film Petlar PR.

### Example 3

Sample 3/HP-Indigo INK/DOW Adcote® 811A+CatF/SRF Limited-PET film Petlar PR.

### Example 4

Sample 4/HP-Indigo INK/DOW Adcote® 811A+CatF/SRF Limited-PET film Petlar PR.

### Reference Example

Reference Sample/HP-Indigo INK/DOW Adcote® 811A+CatF/SRF Limited-PET film Petlar PR.

### General Procedure for Lamination

The printed film was loaded onto a main unwinder. The PET film was loaded onto a second unwinder, Adcote® 811+Cat F was in coating station. The printed film coated by the adhesive was then transferred into an oven for drying (temperature range was 60-120° C.). The lamination apparatus speed was set to 20-400 meter/minute. After evaporation of the solvent(s) the printed and coated film was bound to the PET film using a hot nip [Rubber roll against heated Metal roll with pressure]. The laminated multi-layer was then wound using the rewinder and cured for 7-10 days at a temperature of between room temperature (about 20-25° C.) and 40° C.

### Evaluation of the Transferability Properties

The transferability was evaluated by the visual inspection of the total transferred dots, lines, areas of the different colors used as well as by visual assessment of the percentage of ink coverage to the printed film. All visual inspections were backed-up using optical equipment directly on the prints.

### Evaluation of the Adhesion Properties

The evaluation of the adhesion was carried out by ASTM F and by Finat method 21 Tape test. After the curing step, the lamination strength was tested as per ASTM904F.

### Evaluation of the Abrasion Properties

The Sutherland abrasion tester b was used.

Table 1 summarizes the results obtained for the printed media of the present disclosure when evaluated for their ElectroInk transferability, adhesion and abrasion.

TABLE 1

| | Ink-receiving | | | abrasion |
|---|---|---|---|---|
| | layer | transferability | | Sutherland |
| | Chemical | Visual | adhesion | test 2 pounds × |
| Sample | composition | evaluation | Peeling test | 10st |
| Example 1 | EVA | Good | 98% | Good |
| Example 2 | EAA | Good | 100% | Good |
| Example 3 | EMMA | Good | 100% | Good |
| Example 4 | Tafmer ® | Good | 98% | Good |
| Reference | LDPE | Poor | 0% | Good |
| Example | | | | |

### Thermal Resistance Evaluation

The printed media obtained above were then tested for their thermal resistance.

### Hot Fill Test

A pouch was manufactured from the printed medium obtained in Example 2 according to the following procedure:
General procedure for lamination:
   The printed film was loaded onto a main unwinder. The PET film was loaded onto a second unwinder, Adcote® 811+Cat F was in coating station. The printed film coated by the adhesive was then transferred into an oven for drying (temperature range was 60-1200° C.). The lamination apparatus speed was set to 20-400 meter/minute. After evaporation of the solvent(s) the printed and coated film was bound to the PET film using a hot nip [Rubber roll against heated Metal roll with pressure]. The laminated multi-layer was then wound using the rewinder and cured for 7-10 days at a temperature of between room temperature (about 20-25° C.) and 400° C. Three different technology may be used: solvent Base, solvent Free/less or extrusion Lamination.
Pouch Making. Two generic types:
   Premade Pouch:
      The cured Laminate is put on the pouch making machine.
      Pressure and energy are used i.e. heat or microwaves to create the pouch.
      The pouches are loaded onto the filing machine.
      The machine opens the pouch and fills with the product.
      Seal technology is used to close the pouch entrance.
   Form Fill & Seal [FFS]:
      The Laminate are loaded onto the FFS machine.
      Pressure and energy i.e. heat or microwaves are used to create pouch which is immediately filled with the packaged product and seal at the entrance of the pouch.

Each pouch was then assessed using the following procedure:
1. 140×220 mm pouch filled with 400 cc hot water 75-95° c.
2. The entrance of filled pouch sealed by welder at 150° C.-210° C. for 0.5-2 sec at 2-4 bar pressure.
3. The filled pouches were put on table at room temperature for 24 hrs.
4. The filled pouches were checked in some tests:
   a. Visual test:
      i. Looking for tunnel, bubbles, different color and all any change from the original pouch.
   b. Mechanical test:
      i. Seal strength → the value is not less 90% from the original value.
      ii. Lamination strength → the value is not less 90% from the original value.
   c. Shelf life:
      i. The filled pouches withstand in right condition (mechanical and visual) for 24 months minimum.

The analysis of the print on the hot filled pouch shows that the print was not damaged in the hot fill process. No cracks in the print or ink detachment were observed from visual analysis of the hot filled pouch.

### Pasteurization Test

A printed medium of Example 2 was laminated onto a transparent film of PET 12 micron by application of a layer of 4 gr dry/sqm of solvent-based-lamination adhesive Adcote® 811 (acquired from Dow-Rohm & Haas) and cured for 7 days at 45° C. A laminated packaging was thereby obtained.

A pouch was manufactured from the laminated packaging as follows:
The pouch was sealed at the four extremities.
immersed in boiling water bath or warm water' or warm air (From 76° C.-100° C.) for a period of 20-60 minutes
The pouches were out to room temperature 23-28° C. for 1 hr-24 hrs.
The pasteurized pouches put into carton box.

The pouch was then visually inspected for detection of:
any detachments between layers which usually would show as “bubbles” on the surface of the pouch,
change in the colors of the printed picture taking as reference a non-tested sample,
delaminations,
clear separation between layers,
Leaks of fluid from the pouch through sealing border or/and through the film itself.

In addition the mechanical properties, e.g. the lamination strength and the sealing strength, are reevaluated to ensure that these were not impacted as a result of the thermal treatment (decrease more than 10% from the original value). No damage to the print or packaging integrity was observed from the above-described visual analysis of the hot filled pouch.

In contrast, tests carried out with packaging using primed PET (polyethylene terephthalate) films digitally printed with ElectroInk® and laminated to PE (polyethylene) films with the same lamination adhesive, showed clear deficiencies in the printing and in the lamination integrity (tunneling—construction delaminations) at temperatures higher than 80° C., indicating the superiority of the present disclosure over packaging using primers.

1. A method for performing a Liquid Electrophotographic Printing (LEP) process comprising:
Providing a printing medium, wherein said printing medium comprises an ink-receiving layer and a second layer, the layers being coextruded, wherein at least the ink-receiving layer comprises a material selected from the group consisting of ethylene copolymers, alpha-olefin copolymers, polyamides, polyurethanes, polyvinylpyrrolidones, polyethyleneimines, and mixtures thereof, and
Printing an image on said printing medium.

2. A method according to claim 1, wherein said second layer comprises at least one extrudable thermoplastic polymer.

3. A method according to claim 1, wherein said second layer comprises a low density polyethylene (LDPE) and an ink-receiving layer comprising a material selected from the group consisting of EVA, EAA, EMMA, ethylene alpha-olefin polymer, and mixtures thereof.

4. A method according to claim 1, wherein the Liquid Electrophotographic printing is a one-shot printing process.

5. A method according to claim 1, wherein said printing medium is in the form of a film.

6. A printed medium comprising:
A printing medium as defined in claim 1; and
A LEP ink layer,
wherein said ink layer is in direct contact with said ink-receiving layer.

7. A printed medium according to claim 6, wherein said second layer comprises at least one layer comprising an extrudable thermoplastic polymer.

8. A printed medium according to claim 6, wherein said printing medium comprises a layer comprising of a low density polyethylene (LDPE) and an ink-receiving layer comprising a material selected from the group consisting of EVA, EAA, EMMA, ethylene alpha-olefin polymer, and mixtures thereof.

9. A method for producing a printed medium comprising:
coextruding an ink-receiving layer and a second later thereby obtaining a printing medium as defined in claim 1;
Printing an image on said medium using LEP processes.

10. A method according to claim 9, wherein the method does not comprise:
Coating the ink-receiving layer with an adhesive promoter prior to printing of the image.

11. A printed medium obtainable by a method according to claim 9.

12. A method for producing a packaging comprising:
Providing a printed medium according to claim 6;
Coating the printed medium with an adhesive;
Providing a film; and
Contacting the printed medium and the film.

13. A method according to claim 12, wherein second layer of the printed medium comprises a low density polyethylene (LDPE) and the film comprises a polyester polymer.

14. A method according to claim 2, wherein the Liquid Electrophotographic printing is a one-shot printing process.

15. A method according to claim 3, wherein the Liquid Electrophotographic printing is a one-shot printing process.

16. A printed medium comprising:
A printing medium as defined in claim 2; and
A LEP ink layer,
wherein said ink layer is in direct contact with said ink-receiving layer.

17. A printed medium comprising:
A printing medium as defined in claim 3; and
A LEP ink layer,
wherein said ink layer is in direct contact with said ink-receiving layer.

18. A printed medium according to claim 7, wherein said printing medium comprises a layer comprising of a low density polyethylene (LDPE) and an ink-receiving layer comprising a material selected from the group consisting of EVA, EAA, EMMA, ethylene alpha-olefin polymer, and mixtures thereof.

19. A method for producing a printed medium comprising:
coextruding an ink-receiving layer and a second later thereby obtaining a printing medium as defined in claim 2; and
Printing an image on said medium using LEP processes.

20. A method for producing a printed medium comprising:
coextruding an ink-receiving layer and a second later thereby obtaining a printing medium as defined in claim 3; and
Printing an image on said medium using LEP processes.
